(19) United States
(12) Patent Application Publication
(10) Pub. No.: US 2015/0186312 A1
(43) Pub. Date: Jul. 2, 2015

(54) APPARATUS AND METHOD FOR SENSING OBJECT STATE

(71) Applicant: Petari incorporation, Daejeon (KR)

(72) Inventors: Young Gwan Kim, Daejeon (KR); Young Jin Park, Daejeon (KR)

(21) Appl. No.: 14/565,685

(22) Filed: Dec. 10, 2014

(30) Foreign Application Priority Data
Dec. 27, 2013 (KR) 10-2013-0165583

(51) Int. Cl. G06F 13/32

(52) U.S. Cl. CPC G06F 13/32

(57) ABSTRACT

Provided is an apparatus for sensing an object state. The apparatus includes: a power supply unit configured to supply power; a sensor unit supplied with power from the power supply unit to generate an interrupt signal when a state change of object is detected; a processing unit configured to process the state change of object according to the interrupt signal as at least part of the processing unit is activated in a certain cycle; and a memory configured to store the interrupt signal generated from the sensor unit.

### CROSS-REFERENCE TO RELATED APPLICATION

This application claims priority under 35 U.S.C. §119 from Korean Application No. 10-2013-0165583 filed on Dec. 27, 2013, the subject matter of which is incorporated herein by reference.

### TECHNICAL FIELD

The present invention relates to an apparatus and a method for sensing an object state, and more particularly, to an apparatus and a method for sensing an object state which is useful for a small low-power device based on a battery by reducing power consumption.

### BACKGROUND

A motion detection device including a motion sensor is used to detect a movement of a person or an object. However, in the related art, a change of corresponding object is continuously detected by using the motion sensor so as to detect a specific state of the object, and a motion is detected through a process of calculating and analyzing a value of the motion sensor in real time after reading the value of the motion sensor. In this case, since power is consumed during the process of detecting, calculating, and analyzing the motion by the motion sensor, a large amount of power is consumed.

Therefore, a small battery-operated device requires an effective motion detection method for reducing power consumption.

A method of generating an interrupt signal whenever the motion of object is detected has been suggested as a method for reducing power consumption. An example of such a method is disclosed in Korean Patent Application Laid-Open No. 10-2008-0050797. This application suggests a meter operation detection method that generates operation information of a meter by a microprocessor and stores the information in a memory when an interrupt signal according to a motion of the meter is generated, and transmits the operation information stored in the memory and an inspection data to an external according to a remote inspection signal.

In addition, according to the prior art 1 (http://www.ecnmag.com/articles/2013/04/one-accelerometer-interrupt-pin-both-wakeupand-non-motion-detection), an interrupt is generated to drive a host processor when a motion greater than a threshold set through an acceleration sensor is generated, and a noise of data is reduced by using a low pass filter and a high pass filter after reading data from a sensor. Further, according to the prior art 2 (http://developer.android.com/guide/topics/sensors/sensors_motion.html), a data of X axis, Y-axis, and Z-axis is read so as to detect a motion and a difference between previously read sensor data is calculated to verify whether a motion is occurred.

According to the prior art, the host processor is driven by an interrupt of the motion sensor, and the host processor continuously reads the data from the sensor and reduces a noise of data by using a filter and compares the reduced noise data with a past data to determine whether a motion is occurred. However, in this prior art, since the host processor should continuously maintain a driving state, a large amount of power consumption is required, and the power consumption is increased depending on the number of times of reading the data from the sensor. Accordingly, the method according to such prior art cannot be used in a low-power battery-based system.

### SUMMARY

The present invention may provide an apparatus and a method for sensing an object state which can be used for a low-power battery-based system as power consumption can be significantly reduced.

The present invention further provides an apparatus and a method for sensing an object state which generates an interrupt signal by detecting a motion of object by a motion sensor whenever the object is moved, and performs a filtering and an aggregation of the interrupt signal every certain time to detect a motion and a stop state of the object

In accordance with an aspect of the present invention, an apparatus for sensing an object state includes: a power supply unit configured to supply power; a sensor unit supplied with power from the power supply unit to generate an interrupt signal when a state change of object is detected; a processing unit configured to process the state change of object according to the interrupt signal as at least part of the processing unit is activated in a certain cycle; and a memory configured to store the interrupt signal generated from the sensor unit.

The power supply unit includes a battery that supplies power to the sensor unit and the processing unit.

The sensor unit includes at least one sensor that generates the interrupt signal whenever the state of object is changed.

The processing unit includes: an operation unit supplied with power intermittently from the power supply unit to be activated, and applies filtering and aggregation to the interrupt signal according to a cycle of occurrence of the interrupt signal stored in the memory, and a controller supplied with power continuously from the power supply unit to store the interrupt signal in the memory, and outputs a processing result of the operation unit.

The processing unit removes the interrupt signal generated in a cycle longer than a set cycle by applying the filtering, and integrates the interrupt signal generated in a cycle shorter than the set cycle by applying the aggregation to detect a start time and an end time of the state change of object

The operation unit applies the filtering and the aggregation at least one time.

The processing unit further includes a power controller that controls the power supplied from the power supply unit to supply power continuously to the controller, and supplies power intermittently to the operation unit.

In accordance with another aspect of the present invention, a method for sensing an object state includes: maintaining an activated state of at least part of a processing unit, and maintaining an deactivated state of the remaining part of the processing unit; generating an interrupt signal by detecting a state change of object by a sensor unit; storing the interrupt signal in a memory; and generating a state change detection signal by performing a filtering and an aggregating at least one time to the interrupt signal stored in the memory as the part of the processing unit is activated in a set cycle.

The processing unit includes: a controller supplied with power continuously from a power supply unit; and an operation unit supplied with power intermittently to be activated.

The controller stores the interrupt signal generated from the sensor unit in the memory, and provides the interrupt signal stored in the memory.

The operation unit is supplied with the interrupt signal stored in the memory through the controller, and performs a filtering and an aggregation according to a cycle of occurrence of the interrupt signal.

The operation unit removes the interrupt signal generated in a cycle longer than a set cycle by applying the filtering, and integrates the interrupt signal generated in a cycle shorter than the set cycle by applying the aggregation to detect a start time and an end time of the state change of object.

In an apparatus and a method for sensing an object state according to various embodiments of the present invention, after storing an interrupt signal generated by detecting a motion of object through a sensor in a memory in a state in which the most of a processing unit maintains an inactive state, the processor is activated in a set time to process the interrupt signal stored in the memory. In this case, a filtering and an aggregation are performed at least one time in a cycle of interrupt occurrence to generate a motion detection signal from the beginning of the motion to the end of the motion.

Accordingly, the present invention may reduce power consumption, and thus, may be stably applied to a low-power battery-based system, as a processing unit performs a calculation according to the frequency of occurrence of interrupt signal in a set cycle while the most of the processing unit maintains an inactive state, and then, deactivated again. In addition, the present invention may be applied to a state trace of an object by using a motion sensor that generates an interrupt signal by detecting a motion of the object. In addition, the present invention may be applied to a state trace of an object by using a sensor that generates an interrupt signal by detecting a specific state of the object. For example, when a technology disclosed in the present invention is applied to a sensor that generates an interrupt signal by detecting a change of temperature, a detection of temperature change may be applied to a low-power battery-based system.

The present invention may be applied to all of the case of using a sensor capable of generating an interrupt signal depending on the change of state, regardless of a type of state detection in addition to the motion or the temperature.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of an apparatus for sensing an object state according to an embodiment of the present invention;

FIG. 2 is a diagram of signal waveform for explaining a filtering and an aggregation of an interrupt signal according to an embodiment of the present invention;

FIG. 3 is a block diagram illustrating a configuration of an apparatus for sensing an object state according to another embodiment of the present invention; and

FIG. 4 is a flowchart illustrating a method for sensing an object state according to an embodiment of the present invention.

### DETAILED DESCRIPTION

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

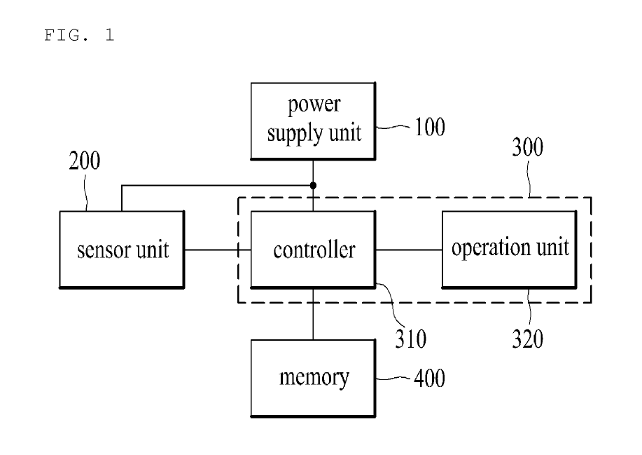

FIG. 1 is a block diagram illustrating a configuration of an apparatus for sensing an object state according to an embodiment of the present invention.

Referring to FIG. 1, the apparatus for sensing an object state according to an embodiment of the present invention may include a power supply unit 100 to supply power, a sensor unit 200 to detect a motion of an object to generate an interrupt signal, a processing unit 300 to process a state of object such as a motion of object according to the interrupt signal when at least part of the processing unit is cyclically activated every certain time, and a memory 400 to store the interrupt signal generated from the sensor unit 200. Meanwhile, in the following embodiment, a motion of object is described as an example, but the present invention may include a state change including the motion.

The power supply unit 100 may provide power for driving the sensor unit 200 and the processing unit 300. The power supply unit 100 may supply power of low voltage by using, for example, a battery. One or more batteries may be used. For example, a single battery of 1.5V may be used, or a plurality of batteries may be used in series, in parallel, or in series-parallel connection.

The sensor unit 200 may be driven by the power supplied from the power supply unit 100, and detect the motion of object. The object may include a thing, a person, or the like, and may include a specific portion of the person in the case of a person. That is, the sensor unit 200 may detect an object or a person moving from one point to another point, and may detect the motion of specific body in the case of a person. Thus, the motion detection apparatus of the present invention may be applied to a system requiring a continuous monitoring of an object state such as a logistics movement system, an intelligent visitor control system, a biological abnormality detection system, or the like. The sensor unit 200 of the present invention may generate an interrupt signal by detecting the motion of object. That is, the sensor unit 200 does not sense the object in a stationary state, but detect the motion only when the object moves to generate the interrupt signal. The interrupt signal generated from the sensor unit 200 may be stored in the memory 400 through the processing unit 300. Meanwhile, various sensors that can detect the motion of object may be used as the sensor unit 200. For example, an optical sensor including a light emitting unit to generate light a light and a receiving unit to receive the light generated from the light emitting unit may be used. Obviously, it is not limited thereto, and an ultrasonic sensor, an infrared sensor, an acceleration sensor or an angular velocity sensor may be used. Further, the sensor unit 200 may use at least one sensor, and may detect the motion of object by complexly using a plurality of sensors. Meanwhile, the sensor unit 200 may further include an amplifier (not shown) to amplify the interrupt signal generated from a sensor. Further, the sensor unit 200 may further include a comparator (not shown). In this case, the sensor outputs a sensing signal by detecting the motion of object, the amplifier amplifies the sensing signal, and a comparator compares the sensing signal amplified by the amplifier with a preset reference voltage and generates an interrupt signal when the sensing signal is higher than the reference voltage. Thus, the sensor unit 200 of the present invention may be implemented of at least one sensor, and may be implemented of at least one sensor, an amplifier, and a comparator.

The processing unit 300 may include a controller 310 and an operation unit 320, and at least part of the processing unit 300 is activated in a set cycle and may process the interrupt signal stored in the memory 400. That is, the controller 310 may be continuously supplied with power to maintain an activated state, and the operation unit 320 may be activated in a set cycle to perform an operation processing such as a filtering and an aggregation of the interrupt signal. The controller 310 may be driven depending on the power supplied from the power supply unit 100, and may be supplied with an interrupt signal from the sensor unit 200 and store in the memory 400. In this case, the controller 310 may ignore the duplicated interrupt signal without storing in the memory 400. That is, when interrupt occurs, corresponding interrupt is indicated in a single variable of the memory 400. By using this variable, only a corresponding value may be maintained whenever interrupt occurs. That is, with a simple code, even interrupt occurs several times, only the same value may be given. Then, the variable may be initialized to zero after a processing that periodically operates. The interrupt which is generated after the processing and the variable is initialized to zero may be stored again in the memory 400. Further, the controller 310 may enable the operation unit 320 to be driven for a set time in a set cycle. That is, the controller 310 may control the power supplied to the operation unit 320 and the driving of the operation unit 320. For example, the controller 310 may control the operation unit 320 to be activated during 30 ms to 100 ms every 1 second to seconds. Then, the controller 310 may provide an interrupt signal to be processed during when the operation unit 320 is activated from the memory 400, and transmit the result processed by the operation unit 320 to user. As described above, since the controller 310 should perform various operations, for example, store the interrupt signal in the memory 400, control the driving of the operation unit 320, and transmit the processing result of the operation unit 320, the controller 310 is continuously supplied with power to maintain an activated state.

The operation unit 320 may maintain a deactivated state, and may be activated for a certain time in a set cycle to process interrupt signal. For example, the operation unit 320 may be activated during 30 ms to 100 ms in a cycle of 1 second to 10 seconds. That is, the operation unit 320 may be supplied with an interrupt signal, which is generated while maintaining the deactivated state and stored in the memory 400, and may process the interrupt signal to generate a motion detection signal. In this case, when the start and end of the motion of object is known, the movement of object can be detected. Therefore, the operation unit 320 may detect the start and the end of interrupt signal by integrating interrupt signals generated during the movement of the object. To this end, the operation unit 320 may detect the moving time and the end time of the object by repeating the filtering and aggregation of interrupt signal multiple times, and may generate a corresponding motion detection signal. That is, the operation unit 320 may remove an interrupt signal having a long cycle of occurrence through filtering, and integrate an interrupt signal having a short cycle of occurrence through aggregation, thereby detecting a moving start time and an end time of object to generate a motion detection signal.

The operation unit 320 may be operated with a designated time interval. For instance, when the operation unit 320 is operated with one second intervals, a long interrupt signal and a short interrupt signal may be distinguished based on the operating time. For example, assuming that interrupt occurs after one second, three seconds, and ten seconds based on a current time, since the operation time of operation unit 320 is one second, it may be determined that an interrupt which occurs after one second and three seconds is occurred in a short period of time, and an interrupt which occurs after ten seconds has a long cycle of occurrence. That is, the operation unit 320 may determine that an interrupt that occurs after one second, two seconds, and seven seconds based on a time interval with which interrupt has occurred with respect to the interrupt that occurs after one second, three seconds, and ten seconds.

Accordingly, aggregation is performed with respect to the interrupt that occurs after one second, and two seconds, whereas filtering is performed with respect to the interrupt that occurs after seven seconds.

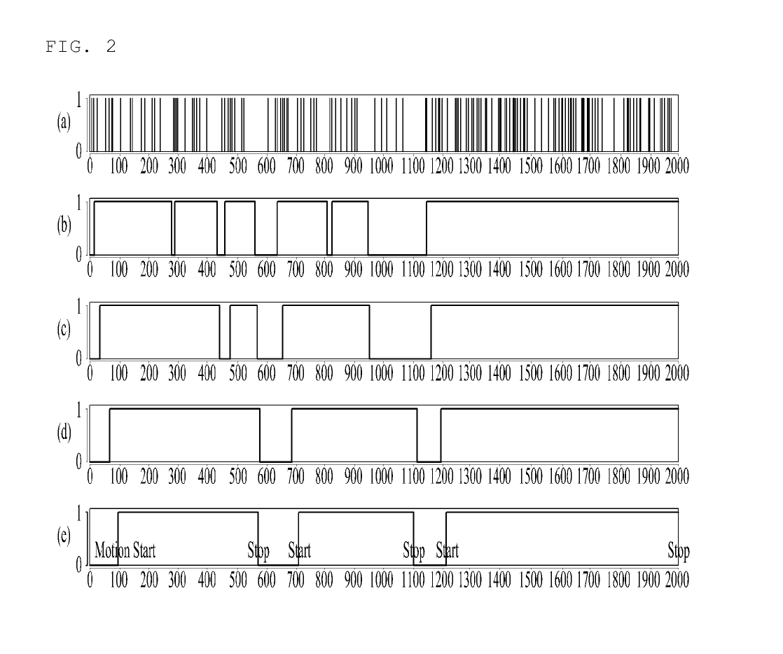

FIG. 2 is a diagram of signal waveform obtained by performing a plurality of filtering and aggregation of an interrupt signal. When interrupt signal having a waveform as shown in FIG. 2A is generated, the operation unit 320 performs a filtering and an aggregation as shown in FIG. 2B, thereby removing an interrupt signal having a long cycle of occurrence, and integrating an interrupt signal having a short cycle of occurrence to simplify signal. In addition, as shown in FIG. 2C and FIG. 2D, the filtering and the aggregation are repeated to remove and integrate the interrupt signal, and finally, as shown in FIG. 2E, a motion detection signal from a motion start time of object to a motion end time.

The motion detection signal, in a section of a signal maintaining high level in FIG. 2E, has a time point of transition from low level to rising state as a motion start time point of object, has a period of maintaining high level as a state in which object continuously moves, and has a time point of transition from high level to low level as a motion end time point of object. Meanwhile, the processing unit 300 may be further provided with an input and output unit (not shown) to input an interrupt signal and output a motion detection signal.

The memory 400 may store the interrupt signal generated from the sensor unit 100. That is, since the operation unit 320 of the processing unit 300 may be activated every set time to process interrupt signal, the interrupt signal generated from the sensor unit 100 is first stored in the memory 400.

The memory 400 may also store an interrupt occurrence time when storing the interrupt signal. For example, the memory 400 may store interrupt signal together with interrupt occurrence time supplied from the sensor unit 100, or may be supplied with interrupt signal from the sensor unit 100 and store the time of storing the supplied interrupt signal. In this case, since the time of storing in the memory 400 is, for example, 10 ms or less or 1 ms or less, there is not much error between a sensing time of the sensor unit 100 and a storage time of the memory 400. That is, the time in which the processor 300 access to the memory 400 is very similar to an operation clock. For example, when operating in a low-power state, if the processor 300 operates in 32 kHz, the time for accessing the memory 400 requires 1 to 4 clock such that 1 clock takes 31 μs. Thus, assuming that the interrupt signal is stored with maximum 4 clock, it takes about 124 μs. Such memory 400 may include volatile memory such as random access memory (RAM), and non-volatile such as flash memory, EEPROM, and the like.

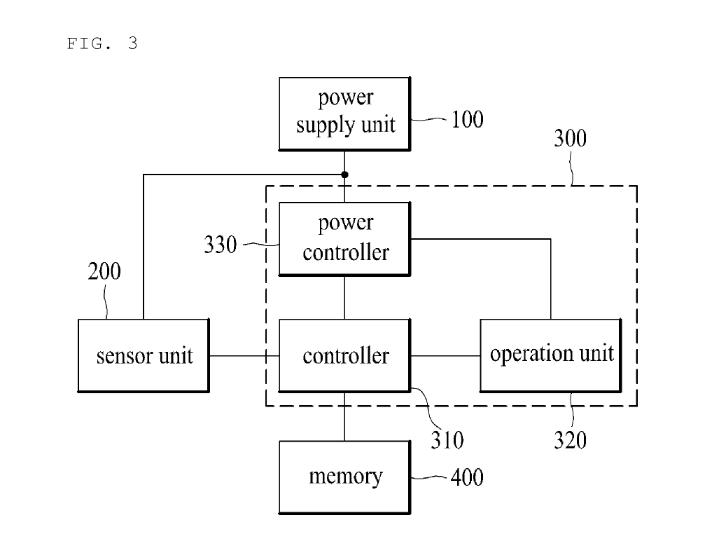

FIG. 3 is a block diagram illustrating a configuration of an apparatus for sensing an object state according to another embodiment of the present invention, and may further include a power controller 330 in the processing unit 300. The power controller 330 may supply power supplied from the power supply unit 100 to the controller 310 and the operation unit 320, may supply power continuously to the controller 310 and supply power to the operation unit 320 for a certain time in a set cycle. In this case, the power controller 330 may be controlled by the controller 310 to control the power supply to the operation unit 320.

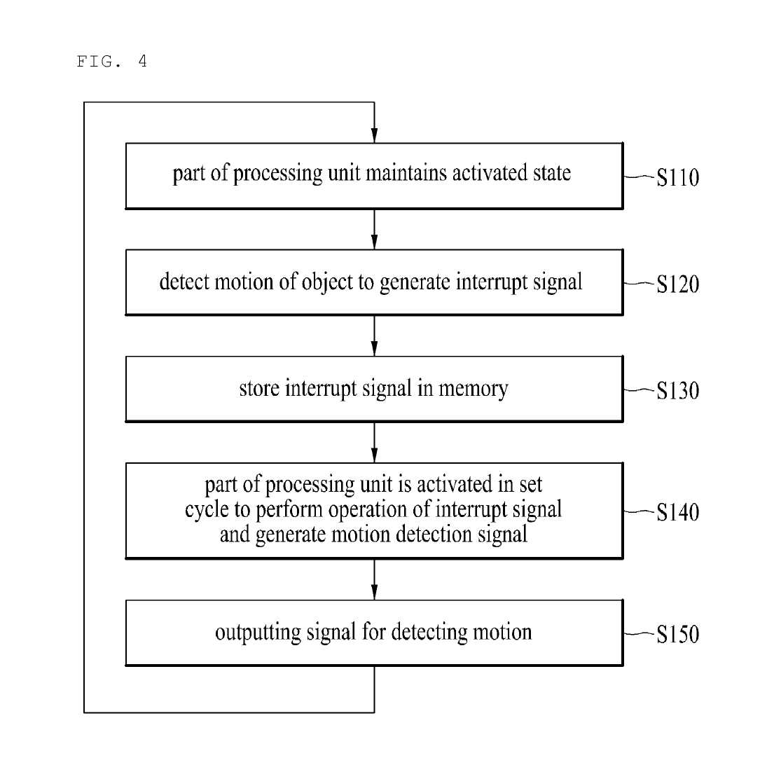

A motion detection method using the apparatus for sensing an object state according to an embodiment of the present invention will be described with reference to FIG. 4.

Referring to FIG. 4, a method for sensing an object state according to an embodiment of the present invention may include a step (S110) in which a part of the processing unit 300 maintains an activated state and a remaining part maintains a deactivated state, a step (S120) in which the sensor unit 200 detects a state change such as the motion of object to generate an interrupt signal, a step (S130) in which the interrupt signal generated from the sensor unit 200 is stored in the memory 400, a step (S140) in which a part of the processing unit 300 is activated in a set cycle to perform a filtering and an aggregation of the interrupt signal multiple times such that a signal for detecting a state change, such as motion of object, is generated, and a step (S150) in which the signal for detecting a state change such as motion of object is outputted, and repeat the above steps S110 to S150. The method for sensing an object state according to an embodiment of the present invention will be described in more detail.

S100: Power is supplied to the sensor unit 200 and the processing unit 300 from the power supply unit 100, such as a battery, that supplies a low power. In this case, a part of the processing unit 300 maintains the activated state, whereas the remaining part maintains the deactivated state. That is, the processing unit 300 may include the controller 310 and the operation unit 320, and the controller 310 maintains the activated state, whereas the operation unit 330 maintains the deactivated state. In other words, the controller 310 of the processing unit 300 may be continuously supplied with power, whereas the operation unit 320 may be periodically supplied with power at a certain time. The power supply cycle of the operation unit 320 may be set to be supplied with power in a cycle of, for example, 1 second to 10 seconds, and be supplied during, for example, 30 ms to 100 ms. Further, the processing unit 300 may be provided with an input and output unit (not shown) to activate an interface with the sensor unit 200.

S120: Then, the sensor unit 200 may continuously detect motion of object, and, accordingly, generate interrupt signal. That is, the sensor unit 200 may generate interrupt signal whenever motion of object is detected, and may continuously generate interrupt signal during the moving of the object. For example, when the object is moved from one point to another point, the sensor unit 200 may continuously generate interrupt signal during when the object moves. Here, the sensor unit 200 may include at least one of sensor. When at least one sensor continuously detects the movement of object to detect the motion of object, the sensor unit 200 may output a corresponding interrupt signal. In this case, the sensor unit 200 may further include an amplifier, and the amplifier may amplify and output interrupt signal.

S130: The interrupt signal generated from the sensor unit 200 may be stored in the memory 400, and may be stored in the memory 400 through the controller 310 of the processing unit 300. That is, the interrupt signal generated from the sensor unit 200 may be continuously stored in the memory 400 through the controller 310. In this case, the memory 400 may store interrupt signal together with its occurrence time. Further, the controller 310 may store interrupt signal in the memory 400 except for a duplicated interrupt signal. That is, when a plurality of interrupt signals are generated during a set time, for example, 0.1 second, the controller 310 may determine the signals as an interrupt signal generated during the moving of a single object thereby ignoring the interrupt signal.

S140: A part of the processing unit 300 may be activated in a set cycle. That is, the operation unit 320 may be activated to process interrupt signal for a certain time, e.g., for 30 ms to 100 ms in a certain cycle, e.g., every 1 second to 10 seconds. In the meantime, when the start time and the end time of the motion of object are known, the movement of object can be detected. Therefore, the operation unit 320 may integrate and process interrupt signals generated during the movement of the object. To this end, the operation unit 320 may be operated during a set time, for example, during 30 ms in a cycle of 1 second, thereby detecting the moving time and the end time of the object by repeating the filtering and the aggregation of interrupt signal stored in the memory 400 multiple times. For example, an interrupt signal having a long cycle of occurrence may be removed from the interrupt signal of FIG. 2A by performing a filtering and an aggregation multiple times as shown in FIG. 2B to FIG. 2D, and a motion detection signal may be generated as shown in FIG. 2E by integrating an interrupt signal which is frequently occurred.

S150: The generated motion detection signal may be outputted to user through the controller 310 and the input and output unit.

Then, after a preset time, the operation unit 320 may be deactivated to repeat steps S110 to S150.

As described above, in the apparatus and the method for sensing an object state according to various embodiments of the present invention, the operation unit 320 of the processing unit 300 maintains an deactivated state, stores the interrupt signal which is generated as the sensor unit 200 detects the motion of object in the memory 400, and then, performs a filtering and an aggregation one time or more according to a cycle of interrupt occurrence with respect to an interrupt signal which is stored in the memory 400 as the operation unit 320 is activated at a set time, thereby generating a motion detection signal from a time point of start of motion of object to a time point of end of motion of object. That is, while most of the processing unit 300 maintains deactivated state, the processing unit 300 performs an operation intermittently, i.e., discontinuously, according to the frequency of the occurrence of interrupt signal in a set cycle, and then, is deactivated again, such that power consumption can be reduced. In the case of using the method of the present invention, a power of about 170 μA˜300 μA is consumed. However, the conventional method of performing an operation continuously by the processing unit while reading sensor data consumes a power of 2800 μA-3500 μA. Accordingly, the present invention minimizes the amount of operation of processing unit 300 and consumes power much less than the conventional method by about 6% to 8%, thereby capable of significantly reducing the power consumption, and being stably applied to a low-power battery-based system.

Further, the apparatus and the method for sensing an object state according to various embodiments of the present invention require to monitor continuously the state of motion sensor, and may be applied to a low-power battery-based system. For example, the present invention may be applied to a logistics movement system that traces a time point at which logistics movement occurs and a time point at which the movement is completed, and traces logistics movement by combining with a location information acquisition technology, and may be applied to an intelligent visitor control system that traces a working position and a moving path by combining with a movement of visitor and a location information acquisition technology. In addition, the present invention may be applied to a biological abnormality detection system that takes immediate measures when a biological abnormality is detected by tracing a bio-signal of a person.

In the meantime, although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

For example, when a temperature of object is increased to a certain temperature or more, if a user desires to detect a start time point and duration of a corresponding state, the method of the present invention may be applied by using a temperature sensor that generates an interrupt at a specific temperature or more. Then, without continuously measuring the temperature, a user can determine a point of time when the temperature of object is increased to a specific temperature or higher, and a time duration in which a corresponding state is maintained, with only a very small amount of power consumption. Thus, it can be seen that the present invention may be applied to a state detection of object having various characteristic values.

What is claimed is:

1. An apparatus for sensing an object state, the apparatus comprising:
a power supply unit configured to supply power;
a sensor unit supplied with power from the power supply unit to generate an interrupt signal when a state change of object is detected;
a processing unit configured to process the state change of object according to the interrupt signal as at least part of the processing unit is activated in a certain cycle; and
a memory configured to store the interrupt signal generated from the sensor unit.

2. The apparatus of claim 1, wherein the power supply unit comprises a battery that supplies power to the sensor unit and the processing unit.

3. The apparatus of claim 1, wherein the sensor unit comprises at least one sensor that generates the interrupt signal whenever the state of object is changed.

4. The apparatus of claim 1, wherein the processing unit comprises:
an operation unit supplied with power intermittently from the power supply unit to be activated, and applies filtering and aggregation to the interrupt signal according to a cycle of occurrence of the interrupt signal stored in the memory; and
a controller supplied with power continuously from the power supply unit to store the interrupt signal in the memory, and outputs a processing result of the operation unit.

5. The apparatus of claim 4, wherein the processing unit removes the interrupt signal generated in a cycle longer than a set cycle by applying the filtering, and integrates the interrupt signal generated in a cycle shorter than the set cycle by applying the aggregation to detect a start time and an end time of the state change of object

6. The apparatus of claim 4, wherein the operation unit applies the filtering and the aggregation at least one time.

7. The apparatus of claim 4, wherein the processing unit further comprises a power controller that controls the power supplied from the power supply unit to supply power continuously to the controller, and supplies power intermittently to the operation unit.

8. The apparatus of claim 2, wherein the processing unit comprises:
an operation unit supplied with power intermittently from the power supply unit to be activated, and applies filtering and aggregation to the interrupt signal according to a cycle of occurrence of the interrupt signal stored in the memory; and
a controller supplied with power continuously from the power supply unit to store the interrupt signal in the memory, and outputs a processing result of the operation unit.

9. The apparatus of claim 8, wherein the processing unit removes the interrupt signal generated in a cycle longer than a set cycle by applying the filtering, and integrates the interrupt signal generated in a cycle shorter than the set cycle by applying the aggregation to detect a start time and an end time of the state change of object

10. The apparatus of claim 8, wherein the operation unit applies the filtering and the aggregation at least one time.

11. The apparatus of claim 8, wherein the processing unit further comprises a power controller that controls the power supplied from the power supply unit to supply power continuously to the controller, and supplies power intermittently to the operation unit.

12. An apparatus for sensing an object state, the apparatus comprising:
a sensor unit configured to generate on/off signals for a certain time according to a state change of object; and
a processing unit configured to compare an interval between adjacent on signals among the generated on signals with a preset interval to detect the state change of object.

13. The apparatus of claim 12, wherein the sensor unit is continuously activated to detect the state change of object, and the processing unit is activated according to a certain cycle to detect a starting point and an end point of the state change of object.

14. The apparatus of claim 12, wherein the sensor unit comprises at least one of an optical sensor, an ultrasonic sensor, an infrared sensor, an acceleration sensor, a temperature sensor, a pressure sensor, a tactile sensor, and an angular velocity sensor.

15. The apparatus of claim 12, wherein the processing unit compares an interval between adjacent on signals among the generated on signals with a preset interval and integrates the on signals when the interval is shorter than the preset interval, and compares an interval between adjacent on signals among the generated on signals with a preset interval and removes the on signals when the interval is longer than the preset interval.

16. The apparatus of claim 12, wherein the sensor unit comprises:
an amplifier configured to amplify a sensing signal for sensing the state change of object; and
a comparator configured to compare the amplified signal with a preset reference signal and generate an on signal when the amplified signal is higher than the reference signal.

17. A method for sensing an object state, the method comprising:
maintaining an activated state of at least part of a processing unit, and maintaining an deactivated state of the remaining part of the processing unit;
generating an interrupt signal by detecting a state change of object by a sensor unit;
storing the interrupt signal in a memory; and
generating a state change detection signal by performing a filtering and an aggregating at least one time to the interrupt signal stored in the memory as the part of the processing unit is activated in a set cycle.

18. The method of claim 17, wherein the processing unit comprises:
a controller supplied with power continuously from a power supply unit; and
an operation unit supplied with power intermittently to be activated.

19. The method of claim 18, wherein the controller stores the interrupt signal generated from the sensor unit in the memory, and provides the interrupt signal stored in the memory.

20. The method of claim 19, wherein the operation unit is supplied with the interrupt signal stored in the memory through the controller, and performs a filtering and an aggregation according to a cycle of occurrence of the interrupt signal.

21. The method of claim 20, wherein the operation unit removes the interrupt signal generated in a cycle longer than a set cycle by applying the filtering, and integrates the interrupt signal generated in a cycle shorter than the set cycle by applying the aggregation to detect a start time and an end time of the state change of object.
